(19) United States
(12) Patent Application Publication
(10) Pub. No.: US 2017/0186100 A1
(43) Pub. Date: Jun. 29, 2017

(54) SYSTEMS AND METHODS FOR GENERATING AND MANAGING CUSTOMER CONTEXT INFORMATION

(71) Applicant: Facebook, Inc., Menlo Park, CA (US)

(72) Inventors: Matthew Logan Schmid, New York, NY (US); Roee Vulkan, Closter, NJ (US)

(21) Appl. No.: 14/980,543

(22) Filed: Dec. 28, 2015

(51) Int. Cl. G06Q 50/00; G06Q 30/02

(52) U.S. Cl. CPC G06Q 50/01; G06Q 30/0201

(57) ABSTRACT

Systems, methods, and non-transitory computer-readable media can establish a merchant account on a social networking system associated with a first merchant. A customer profile associated with the first merchant and a first customer is established. Customer context information associated with the first customer profile is generated without merchant intervention based on a customer context information rule.

### FIELD OF THE INVENTION

The present technology relates to the field of social networks. More particularly, the present technology relates to generating and managing customer context information.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Merchants can advertise to and interact with users on the social networking system. The social networking system can offer various products, features, and services that enhance a merchant's ability to effectively engage users on the social networking system. The effectiveness of these various products, features, and services offered to merchants can be enhanced as the social networking system becomes more knowledgeable about users and merchants that it serves. This information can be leveraged by the social networking system to optimize products and services offered to both users and merchants.

### SUMMARY

Various embodiments of the present disclosure can include systems, methods, and non-transitory computer readable media configured to establish a merchant account on a social networking system associated with a first merchant. A customer profile associated with the first merchant and a first customer is established. Customer context information associated with the first customer profile is generated without merchant intervention based on a customer context information rule.

In an embodiment, the customer context information is generated based on an action taken by the first customer.

In an embodiment, the customer context information is generated based on a message sent by the first customer.

In an embodiment, the customer context information comprises a customer tag.

In an embodiment, a plurality of customers are filtered based on the customer tag.

In an embodiment, a subset of the plurality of customers associated with the customer tag are interacted with.

In an embodiment, the customer context information comprises a customer note.

In an embodiment, a customer note manually entered by a merchant administrator is received.

In an embodiment, the customer note manually entered by the merchant administrator comprises a mention of a second merchant administrator, and the second merchant administrator is notified of the customer note.

In an embodiment, a customer context interface is presented to the first merchant.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a customer context module, according to an embodiment of the present disclosure.

FIG. 2 illustrates a customer context information module, according to an embodiment of the present disclosure.

FIG. 3 illustrates an example scenario including an example customer context interface, according to an embodiment of the present disclosure.

FIG. 4 illustrates an example method for generating customer content information without merchant intervention, according to an embodiment of the present disclosure.

FIG. 5 illustrates an example method for managing customer content information, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Social Network Customer Context Information Management

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can add friends or contacts, provide, post, or publish content items, such as text, notes, status updates, links, pictures, videos, and audio, via the social networking system.

Merchants can reach users of a social networking system by posting content, including advertisements, and interacting with users on the social networking system. As users and merchants interact on the social networking system, the system receives and stores more information and learns more about the users and merchants that it serves. Information on interactions between users and merchants can be leveraged by the social networking system to optimize the presentation of relevant products and features to both users and merchants. Products and services can be offered to a merchant to increase the effectiveness of the merchant's interactions with users on the social networking system.

It continues to be an important interest for a social networking system rooted in computer technology to maximize the effectiveness of merchant-customer interaction on the social networking system. However, it can be difficult to analyze available information to effectively provide products and services to merchants to increase the effectiveness of merchant-customer interactions on the social networking system. Although a wealth of information is potentially available to both the social networking system and merchants, it is a challenge to determine how best to utilize available information to benefit merchants and their customers on the social networking system.

Therefore, an improved approach can be beneficial for overcoming these and other disadvantages associated with conventional approaches. Based on computer technology, the disclosed technology can generate and store customer context information based on customer interactions with a merchant. Customer context information can include customer tags to categorize customers, customer interaction history, and customer notes. Customer notes and tags can be automatically generated, i.e., without merchant intervention, based on customer context information rules specified by the merchant. Customer notes and tags can be utilized to filter, sort, or rank customers. Although users on a social networking system will be referred to herein as “customers,” it should be understood that customers can include any users on the social networking system, and need not be limited to users who have previously made a purchase with a merchant.

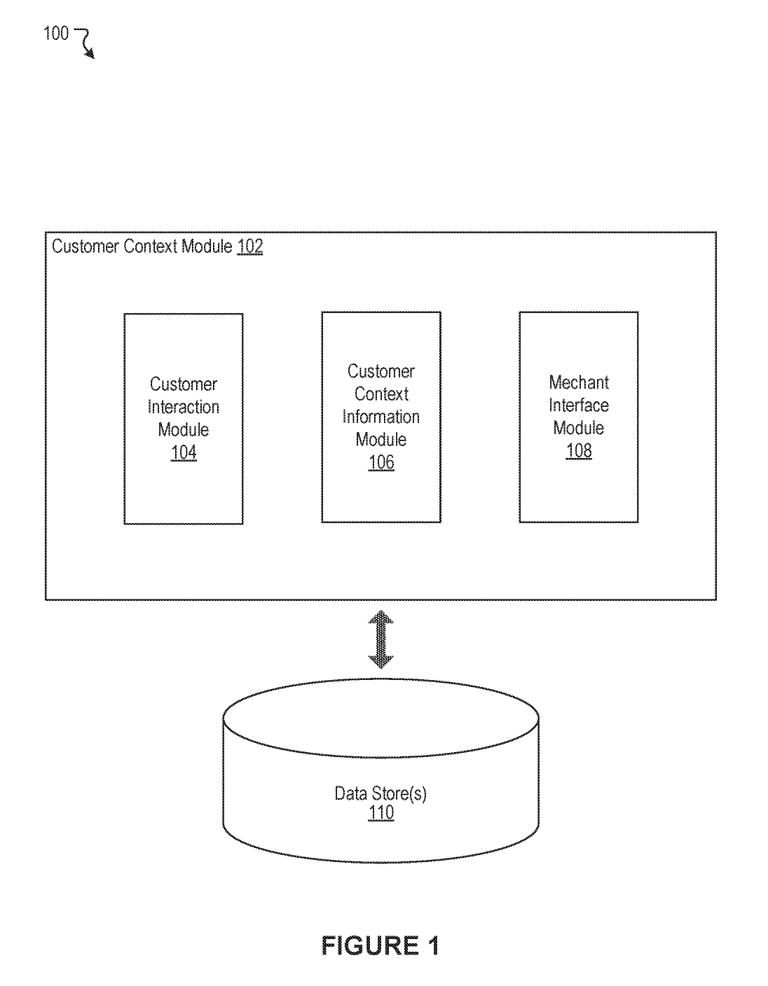

FIG. 1 illustrates an example system 100 including an example customer context module 102 configured to generate and manage customer context information, according to an embodiment of the present disclosure. The customer context module 102 can be configured to allow a merchant to interact with one or more customers. For example, a merchant account can be established on a social networking system and customers may be given the ability to send messages to the merchant account, to post content to a page associated with the merchant account, to view and interact with content posted by the merchant (e.g., liking, commenting, or sharing the content), and the like. Each merchant can maintain a set of customer profiles, including customer context information. For example, each customer of a merchant can be assigned a unique customer profile, and customer tags and customer notes can be created by the merchant and applied to a customer's customer profile. This information can be used to keep a history of each customer's interactions with the merchant, and to assist the merchant in more effectively interacting with each customer in the future. Customer notes can be created by administrators of the merchant account, e.g., employees of the merchant with access privileges on the merchant's account, or can be automatically generated based on customer note rules defined by the merchant, without further merchant intervention. Similarly, customer tags can be generated by administrators or automatically generated based on customer tag rules. The customer context module 102 can be further configured to present customer context information to a merchant via a customer context interface.

As shown in the example of FIG. 1, the customer context module 102 can include a customer interaction module 104, a customer context information module 106, and a merchant interface module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The customer interaction module 104 can be configured to allow a merchant to interact with one or more users on a social networking system. For example, in various embodiments, a merchant can have a page on the social networking system associated with the merchant. Users can “like” or “favorite” the merchant's page to indicate interest in the merchant. The merchant can post content to the merchant's page. Users can interact with content posted by the merchant by, for example, liking the content, sharing the content, commenting on the content, and the like. Users may also be given the ability to post content to the merchant's page, or to send messages to the merchant, for example, via a messaging application on the social networking system.

The merchant can also interact with users or customers on the social networking system by advertising on the social networking system. For example, each customer may have a news feed that compiles various content posts into a feed. Merchant advertisements may be presented in a customer's news feed, or in designated advertisement portions of a customer's social networking system interface. A customer can interact with merchant advertisements by, for example, clicking on the advertisement to lead the customer to the merchant's page on the social networking system or to the merchant's website, or commenting on, liking, or sharing the advertisement. In another example, a merchant advertisement may contain a “call to action” that recommends a particular action by a customer (e.g., liking the merchant's page on the social networking system) and may include a button or a link that allows the customer to take the recommended action. Additional examples of merchant-customer interactions on a social networking system will be described in greater detail herein.

The customer context information module 106 can be configured to receive, generate, and/or maintain customer context information associated with various customers or users on a social networking system. Two examples of customer context information include customer notes and customer tags. Customer notes can include notes that are input by a merchant administrator to record notes about interactions with a customer. Customer notes can also be generated automatically based on customer interactions with the merchant. Customer tags can be generated to categorize customers based on various characteristics or interactions. For example, customers can be tagged as a “VIP customer” if they spend a certain amount of money with the merchant, or can be tagged as a “new customer” if they recently made their first purchase with the merchant. Any number of customer tags can be defined by a merchant to suit the merchant's needs. Customer tags may be generated by a merchant administrator, or generated automatically, i.e., without merchant intervention, based on various customer tag rules. The customer context information module 106 can be configured with various customer context information rules (e.g., customer note rules or customer tag rules) to automatically generate customer context information without merchant intervention when certain events or interactions occur. The customer context information module 106 is discussed in greater detail herein.

The merchant interface module 108 can be configured to present customer context information to a merchant. The merchant can utilize customer context information to inform and/or improve interactions with customers. For example, the merchant interface module 108 can be configured to present a customer context card associated with a particular customer that displays customer context information associated with the customer, such as customer notes, customer tags, any messages sent to the merchant by the customer, any content posted to the merchant's page by the customer, whether and when the customer has liked the merchants page on the social networking system, the customer's demographic information, and the like. In various embodiments, the merchant interface module 108 can also be configured to allow a merchant to filter a set of customers based on customer context information so as to interact with a particular group of customers. For example, the merchant can filter customers based on customer tags, e.g., to see all customers who have recently made their first purchase and have been tagged as “new customers.” The merchant can then take an action specific to those customers or a subset of those customers. In the “new customers” example, the merchant can choose to send a welcome message to all new customers, or to offer a discount to new customers for their next purchase. The merchant interface module 108 is discussed in greater detail herein.

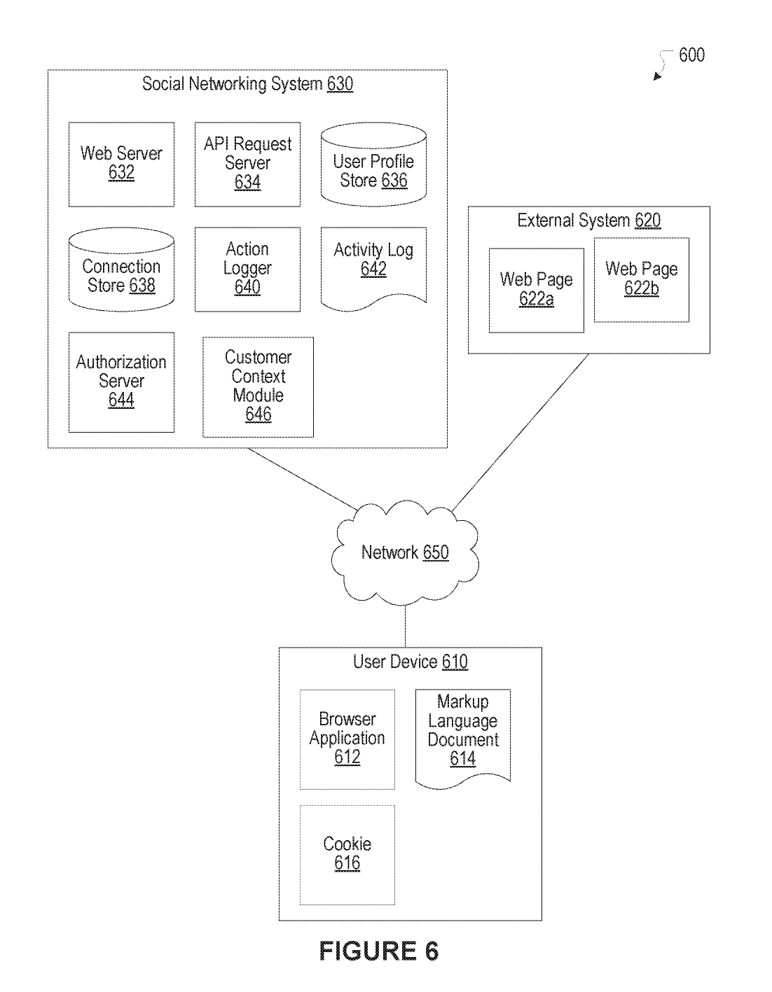

The customer context module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the customer context module 102 can be implemented, in part or in whole, as software running on one or more computing devices or systems, such as on a server computing system or a user (or client) computing system. For example, the customer context module 102 or at least a portion thereof can be implemented as or within an application (e.g., app), a program, or an applet, etc., running on a user computing device or a client computing system, such as the user device 610 of FIG. 6. In another example, the customer context module 102 or at least a portion thereof can be implemented using one or more computing devices or systems that include one or more servers, such as network servers or cloud servers. In some instances, the customer context module 102 can, in part or in whole, be implemented within or configured to operate in conjunction with a social networking system (or service), such as the social networking system 630 of FIG. 6. It should be understood that there can be many variations or other possibilities.

The customer context module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the customer context module 102. For instance, the data store 110 can store customer context information, customer context information rules, customer interaction history, customer demographic information, and any other information that may be used to carry out the present technology disclosed herein. It is contemplated that there can be many variations or other possibilities.

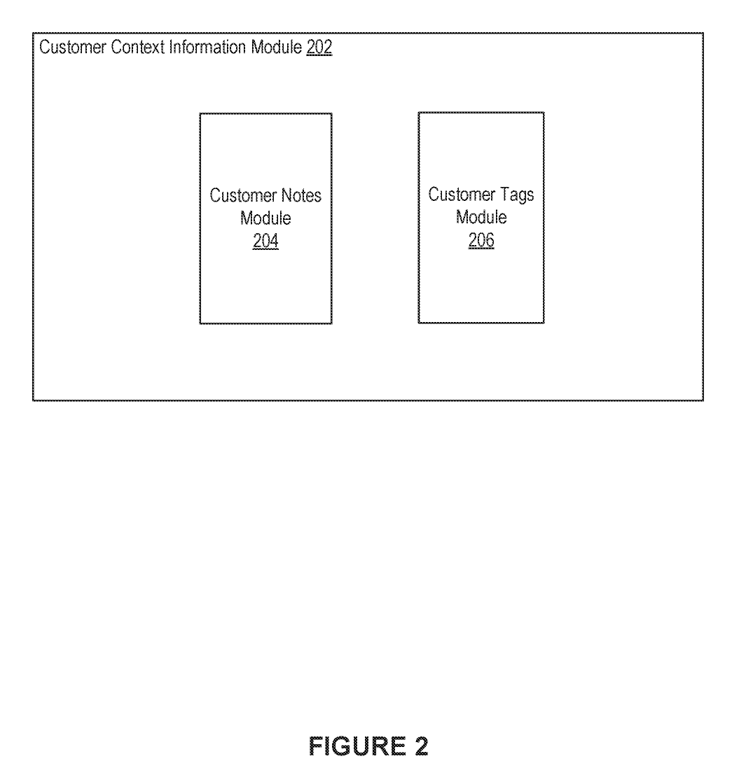

FIG. 2 illustrates an example customer context information module 202 configured to receive, generate, and/or maintain customer context information, according to an embodiment of the present disclosure. In some embodiments, the customer context information module 106 of FIG. 1 can be implemented as the example customer context information module 202. As shown in FIG. 2, the customer context information module 202 can include a customer notes module 204 and a customer tags module 206.

The customer notes module 204 can be configured to receive, generate, and/or maintain customer notes. In various embodiments, the customer notes module 204 can be configured to receive customer notes associated with a particular customer. Customer notes can be received from merchant administrators associated with a merchant. Merchant administrators can include employees and/or contractors associated with a merchant and having permission to update customer context information. An interface can be provided to allow merchant administrators to input notes for a particular customer. Customer notes can be stored and maintained to be utilized in future interactions with a customer. For example, a merchant administrator can make a note when a customer sends a message about a particular issue, and can note whether and when the issue was resolved. This information could be beneficial in future interactions with the customer by providing some contextual information for the customer's previous interactions with the merchant.

In various embodiments, merchant administrators can communicate with one another about a particular customer by creating customer notes. In certain embodiments, a particular merchant administrator can be notified of a customer issue by being tagged or mentioned in a customer note. For example, if a first merchant administrator notices that a customer has sent an inquiry about a product shipment, the first merchant administrator can notify a second merchant administrator of the issue by creating a customer note in which the second merchant administrator is mentioned. The second merchant administrator can respond to the first merchant administrator by posting a follow-up customer note that addresses the issue.

In various embodiments, the customer notes module 204 can be configured to automatically generate customer notes based on one or more customer note rules. A customer note rule can be defined by the merchant to generate a customer note whenever a particular event occurs. For example, when a user “likes” the merchants page on a social networking system, a customer note can automatically be generated indicating the date on which the user liked the merchant's page. As can be seen from this example, a customer note can be automatically generated without further merchant intervention beyond the initial definition of a customer note rule. In another example, if a user sends an inquiry (e.g., by posting to the merchant's page or messaging the merchant via a messaging application), a customer note can automatically be generated recording the user's inquiry. In various embodiments, the customer note may be generated based on the contents of the user's interaction or inquiry. For example, if a customer sends a message about an order shipment, the content of the message can be analyzed, and a customer note can be automatically generated informing a merchant administrator in the shipping department of the customer's inquiry. Similarly, if a customer sends a question about a particular product, and the product is identified by a product number, then a customer note can automatically generated notifying an administrator familiar with the identified product.

In various embodiments, a customer note can be generated based on the actions of the user. For example, if a customer responds to an advertisement that says the customer can receive 10% off a purchase if they like the merchant's page, and the customer goes on to like the merchant page (e.g., via a “like” button on the advertisement), a customer note can be generated that the customer liked the merchant page in response to the advertising campaign. Similarly, if the merchant offers a discount for users who share a particular content post, a customer note can be generated indicating that a customer has shared the content post.

The customer tags module 206 can be configured to receive, generate, and/or maintain customer tags. Similar to the customer notes discussed above, customer tags can be input by a merchant administrator, or can be automatically generated based on one or more customer tag rules. In various embodiments, a customer tag can be generated based on an action taken by a customer. The merchant can specify a customer tag rule indicating that a customer will receive a particular tag if the customer takes a particular action. For example, a customer may receive a “new customer” tag once he or she makes a first purchase, or the customer may be tagged as a “VIP customer” if the customer satisfies a purchase threshold, and the like. Customer tags can also be generated based on the content of a customer's interaction with the merchant. The merchant can create a customer tag rule to tag customers based on particular keywords or content in the customer's interaction. For example, if a customer responds to a particular advertising campaign by using a keyword (e.g., a discount code), then the customer can be tagged as having participated in the advertising campaign. Customer tags can also be generated based on user demographic information, user characteristics, user activity on a social networking system, or any other information available to the merchant.

It should also be appreciated that various actions or interactions taken by a customer may result in both a customer tag and a customer note being generated. For example, if a customer responds to a particular advertising campaign, the customer can be tagged as a participant in the advertising campaign, and a customer note can be generated indicating the date on which the customer responded to the advertising campaign. A customer note can also be generated based on generation of a customer tag, or vice versa.

Customer tags and/or customer notes can be utilized to group customers in various configurations. In various embodiments, merchants can filter customers based on customer tag information so that the merchant can identify a particular group or subset of identified customers (e.g., new customers, VIP customers, etc.) who have responded to a particular advertising campaign or who fit a particular demographic to name some examples. By filtering customers based on customer context information, such as tags and notes, a merchant can target its interactions with customers based on shared characteristics of customers to increase the effectiveness of the merchant's interactions with its customers.

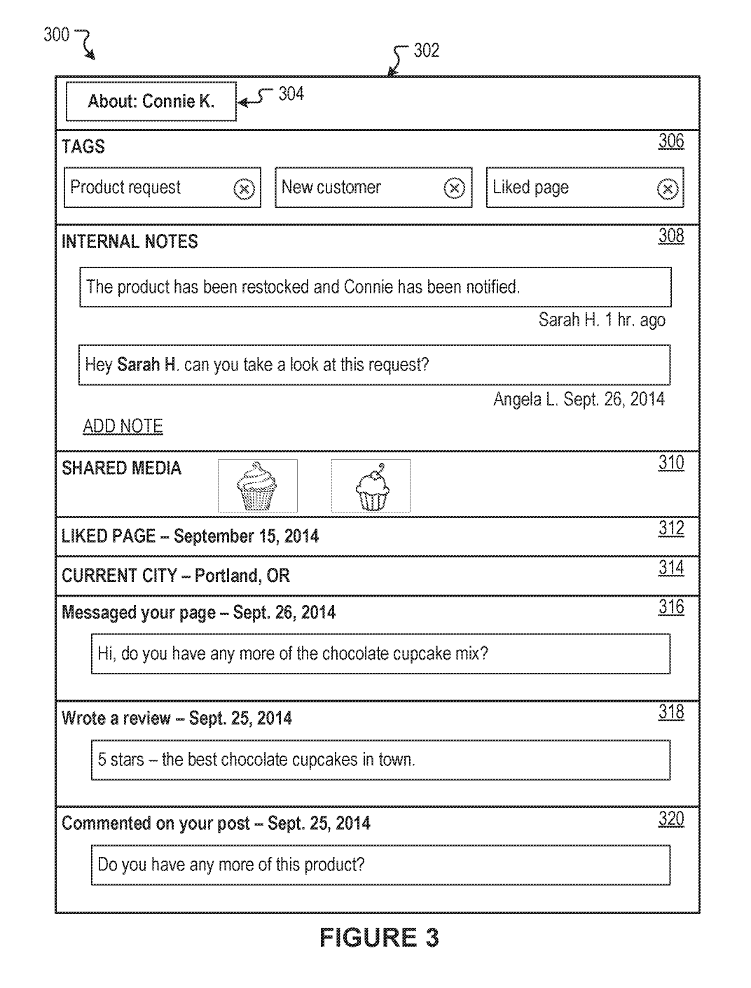

FIG. 3 illustrates an example scenario 300 associated with managing customer context information, according to an embodiment of the present disclosure. The example scenario 300 illustrates an example interface 302 for providing a customer context interface to a merchant. The example interface 302 of FIG. 3 presents customer context information for a customer Connie K., as indicated by a box 304. A customer tag box 306 presents the various customer tags associated with the customer's customer profile, and allows a merchant administrator to manually add customer tags. An internal notes box 308 presents customer notes for the customer, and allows a merchant administrator to manually add customer notes. In the example shown in FIG. 3, a first administrator Angela L. has noticed a message from Connie K. (message box 316), and has tagged a second administrator Sarah H. to address Connie K.'s inquiry. Sarah H. then posted a responsive note indicating that the product requested by Connie K. has been restocked, and Connie K. has been notified.

A shared media box 310 includes various media items shared with the customer by the merchant, such as photographs or videos sent to the customer by the merchant. A liked page box 312 indicates whether or not the customer has liked the merchant's page, and if so, presents the date on which the customer liked the merchant's page. A current city box 314 presents the customer's current city of residence. A messages box 316 presents previous messages sent to the merchant by the customer and the date and time of the messages. In this example, Connie K. sent a message inquiring about chocolate cake mix on Sep. 26, 2014. A review box 318 presents any reviews of the merchant posted by the customer. A comments box 320 presents any comments made by the customer to content posts made by the merchant, e.g., on the merchant's page on a social networking system. The information presented in the example interface 302 can be utilized by a merchant and its administrators to inform and improve present and future interactions with the customer by the merchant.

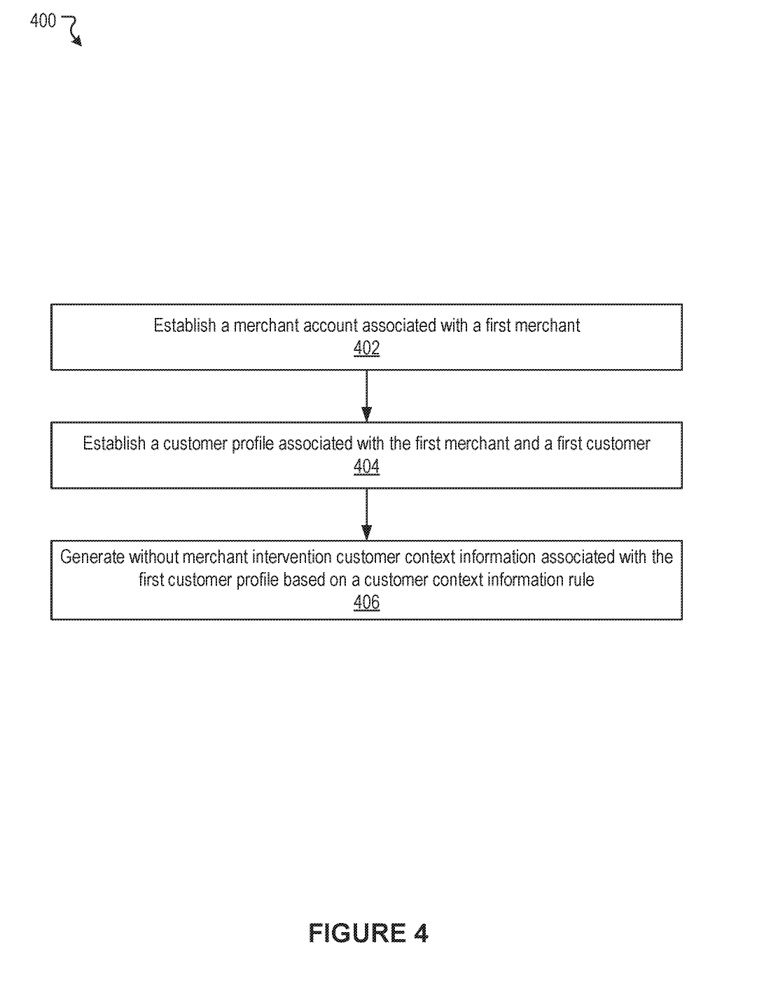

FIG. 4 illustrates an example method 400 associated with automatically generating customer context information, according to an embodiment of the present disclosure. It should be appreciated that there can be additional, fewer, or alternative steps performed in similar or alternative orders, or in parallel, based on the various features and embodiments discussed herein unless otherwise stated.

At block 402, the example method 400 can establish a merchant account associated with a first merchant. At block 404, the example method 400 can establish a customer profile associated with the first merchant and a first customer. At block 406, the example method 400 can generate without merchant intervention customer context information associated with the first customer profile based on a customer context information rule.

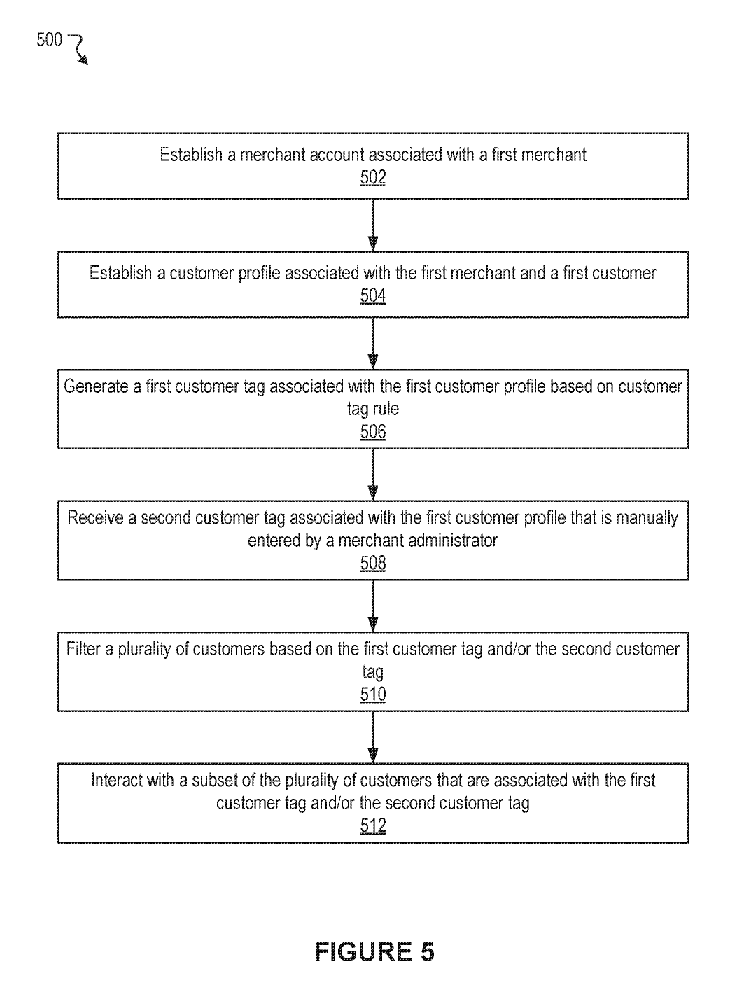

FIG. 5 illustrates an example method 500 associated with managing customer context information, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can establish a merchant account associated with a first merchant. At block 504, the example method 500 can establish a customer profile associated with the first merchant and a first customer. At block 506, the example method 500 can generate a first customer tag associated with the first customer profile based on a customer tag rule. At block 508, the example method 500 can receive a second customer tag associated with the first customer profile that is manually entered by a merchant administrator. At block 510, the example method 500 can filter a plurality of customers based on the first customer tag and/or the second customer tag. At block 512, the example method 500 can interact with a subset of the plurality of customers that are associated with the first customer tag and/or the second customer tag.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a customer context module 646. The customer context module 646 can, for example, be implemented as the customer context module 102, as discussed in more detail herein. As discussed previously, it should be appreciated that there can be many variations or other possibilities. For example, in some embodiments, one or more functionalities of the customer context module 646 can be implemented in the user device 610.

### Hardware Implementation

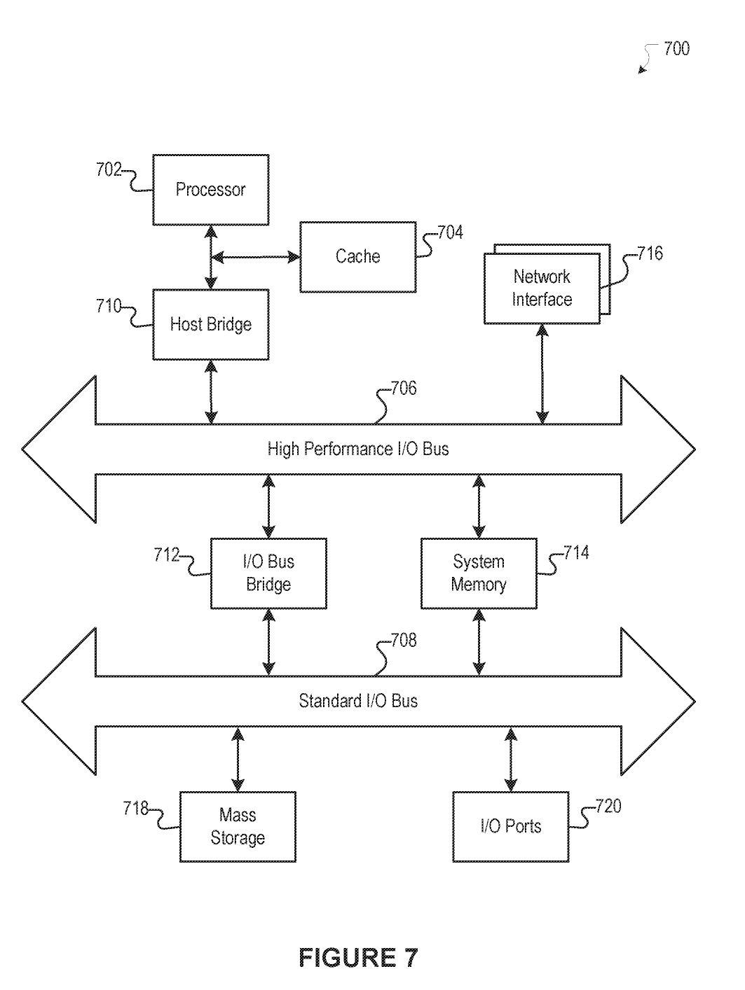

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
establishing, by a computing system, a merchant account on a social networking system associated with a first merchant;
establishing, by the computing system, a customer profile associated with the first merchant and a first customer; and
generating, by the computing system, without merchant intervention customer context information associated with the first customer profile based on a customer context information rule.

2. The computer-implemented method of claim 1, wherein the customer context information is generated based on an action taken by the first customer.

3. The computer-implemented method of claim 1, wherein the customer context information is generated based on a message sent by the first customer.

4. The computer-implemented method of claim 1, wherein the customer context information comprises a customer tag.

5. The computer-implemented method of claim 4, further comprising filtering a plurality of customers based on the customer tag.

6. The computer-implemented method of claim 5, further comprising interacting with a subset of the plurality of customers that are associated with the customer tag.

7. The computer-implemented method of claim 1, wherein the customer context information comprises a customer note.

8. The computer-implemented method of claim 1, further comprising receiving a customer note manually entered by a merchant administrator.

9. The computer-implemented method of claim 8, wherein the customer note manually entered by the merchant administrator comprises a mention of a second merchant administrator, and the method further comprising notifying the second merchant administrator of the customer note.

10. The computer-implemented method of claim 1, further comprising presenting a customer context interface to the first merchant.

11. A system comprising:
at least one processor; and
a memory storing instructions that, when executed by the at least one processor, cause the system to perform a method comprising:
establishing a merchant account on a social networking system associated with a first merchant;
establishing a customer profile associated with the first merchant and a first customer; and
generating without merchant intervention customer context information associated with the first customer profile based on a customer context information rule.

12. The system of claim 11, wherein the customer context information is generated based on an action taken by the first customer.

13. The system of claim 11, wherein the customer context information is generated based on a message sent by the first customer.

14. The system of claim 11, wherein the customer context information comprises a customer tag.

15. The system of claim 14, wherein the method further comprises filtering a plurality of customers based on the customer tag.

16. A non-transitory computer-readable storage medium including instructions that, when executed by at least one processor of a computing system, cause the computing system to perform a method comprising:
establishing a merchant account on a social networking system associated with a first merchant;
establishing a customer profile associated with the first merchant and a first customer; and
generating without merchant intervention customer context information associated with the first customer profile based on a customer context information rule.

17. The non-transitory computer-readable storage medium of claim 16, wherein the customer context information is generated based on an action taken by the first customer.

18. The non-transitory computer-readable storage medium of claim 16, wherein the customer context information is generated based on a message sent by the first customer.

19. The non-transitory computer-readable storage medium of claim 16, wherein the customer context information comprises a customer tag.

20. The non-transitory computer-readable storage medium of claim 19, wherein the method further comprises filtering a plurality of customers based on the customer tag.
